(19) United States
(12) Patent Application Publication
(10) Pub. No.: US 2009/0091885 A1
(43) Pub. Date: Apr. 9, 2009

(54) ALI system

(76) Inventor: Cecelia Burford, Reading, PA (US)

Correspondence Address: Cecelia Burford, 567 S. 14th St, Reading, PA, 19602, US

(21) Appl. No.: 12/286,843

(22) Filed: Oct. 2, 2008

Related U.S. Application Data
(60) Provisional application No. 60/997,828, filed on Oct. 5, 2007.

(51) Int. Cl. G06F 1/16

(52) U.S. Cl. 361/679.55

(57) ABSTRACT

A laptop that fuses external components such as a printer, scanner, fax machine and miniature solar panels into an all-in-one laptop with prolonged battery life. Below the computer keyboard area is an additional compartment that holds the scanner with the bottom of the keyboard area acting like a scanner cover. The back of the laptop screen holds the small printer for printing word or design documents along with miniature solar panels.

(This application claims priority of a provisional application No. 60/997,828 and which was filed on Oct. 5, 2007)

### BACKGROUND OF THE INVENTION

1. Technical Field

This invention relates to the Technology and Computer, more specifically to Laptops and Computer Accessories.

2. Description of Related Art

The major crux of the business world revolves heavily around the resources available to both a company and individual. It's almost a standard for any business person, student or person to have a computer and its major accessories to fulfill multiple functions sometimes on the spot. A big advancement was the invention of the laptop portable computer which allowed people to break out of their home and offices and have computer capabilities on the go. Laptops are becoming as powerful as desktop computers and are continuously being improved. Such improvements can be found patented:
U.S. Pat. No. 6,273,310
U.S. Pat. No. 1,628,191
U.S. Pat. No. 0,109,662

However most improvements in laptops involve improving features to be used in a different way; such as a smoother running program, a screen opening a different way or a sleek new look to the same laptop. All these new models are appreciated by customers however what is now needed is an integration of multiple desktop computer accessories into a laptop to advance its list of operations. In fact you the person reading this might be at either a desktop computer with a connected personal printer or network printer. Or you might be at a Laptop of your own but have to purchase additional equipment or inconveniently go somewhere in order to print, send a fax or scan a document for emailing. Imagine all these capabilities being at your fingertips at the moment you purchase your laptop. This invention is to turn that imagination into reality.

### SUMMARY OF INVENTION

The sole purpose of the ALI Laptops are to satisfy the desire of having a complete work area at the users fingertips at home or on the road without the financial burden and spatial dimensions needed for additional equipment; all this in a eye catching design that does not look bulky. This purpose is met with the following features. A small ten inch Feeding Printer mounted on back of screen that can print out documents and graphics by hand feeding paper through the printer eliminating any need to carry around large amounts of paper. The Digital Camera built into front of laptop allows for digital pictures or recording. The Scanner conveniently built into bottom of laptop in its own compartment allows for scanning, having its own compartment strategically placed under the keyboard area allows for a compact Laptop without any extra bulkiness. In addition, the Fax Machine that is integrated into the Small Feeding Printer functions with a Fax reader bar that can be swapped out with the printing rod to convert the printer into a fax machine or integrated with the scanner to make a two-in one fax/scanner. The scanner can also be used in conjunction with the printer to provide the services of a copier by sending information from the scanner to the Small Feeding Printer for multiple print outs.

For security purposes the Personal Bio-Technology replaces the need of remembering troublesome passwords and simply uses user's fingerprint as security. Speakers for the entertainment of sound for music, movies or communication are a common feature in most Laptops. The Touch Screen Technology built in so users can conveniently and quickly select and navigate on the computer as an option adds to a user friendly interface that otherwise might be troublesome or difficult with a finger mouse or typing. The DVD/CD Burner gives the user the freedom to take audio, video or information files with them by burning them onto CD and also allows them to watch, listen or open CD's. Because of the flaw of battery lifespan with Laptops the feature of miniature solar panels filtering power to the battery pack is ideal for prolonged usage.

Again, the design of The ALI Laptops is specially designed to please the eye and to avoid bulkiness. Without having multiple things protruding from different places the ALI Laptops makes all the mentioned features easily accessible and user friendly all with the simplicity that both veteran and new users can appreciate without all the clutter.

### BRIEF DESCRIPTION OF THE DRAWINGS

FIG. 1 is a closed overview of the ALI Laptop.

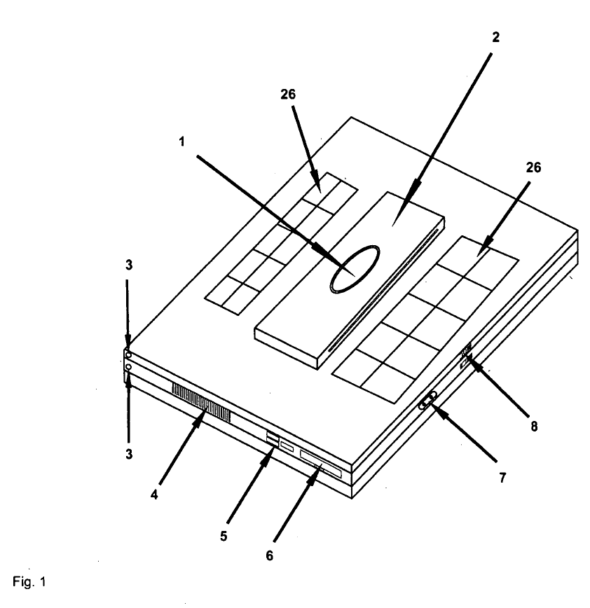

FIG. 2 is a closed frontal view of the ALI Laptop.

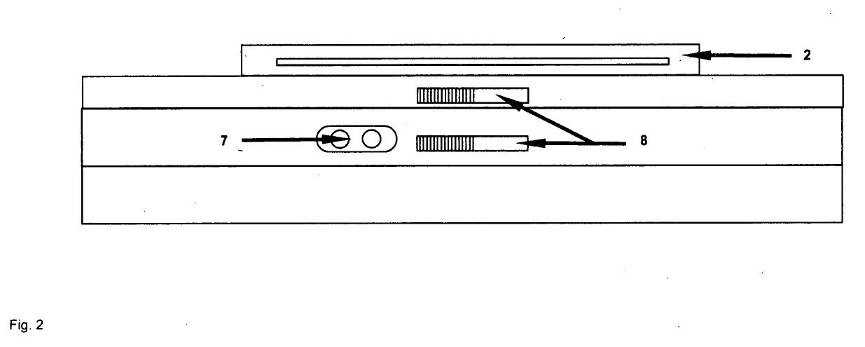

FIG. 3 is a closed rear view of the ALI Laptop.

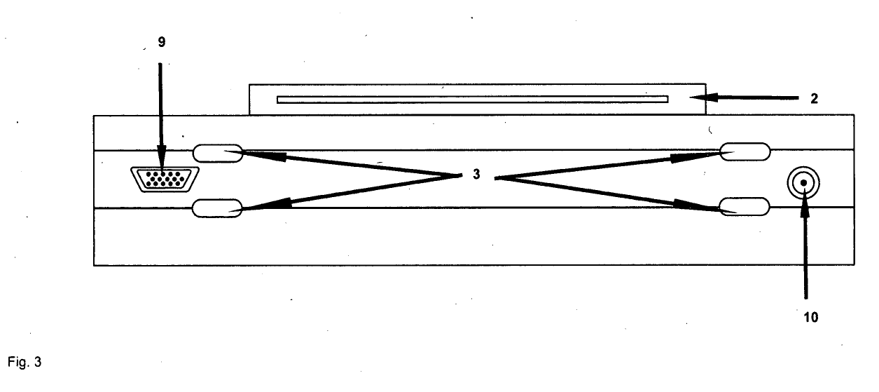

FIG. 4 is a closed left sided view of the ALI Laptop.

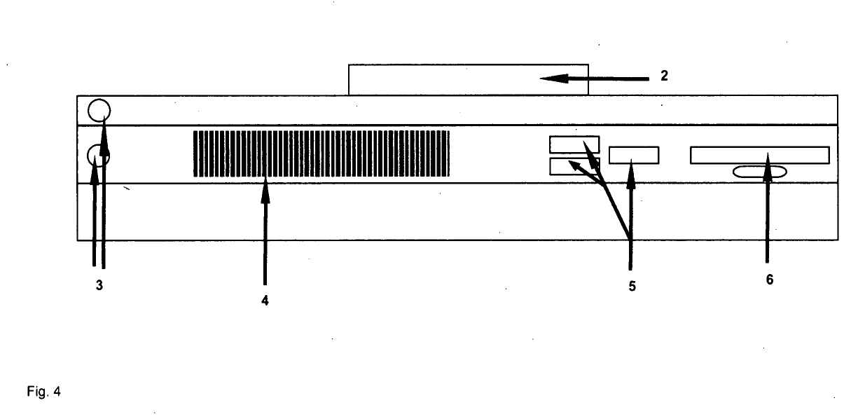

FIG. 5 is a closed right sided view of the ALI Laptop.

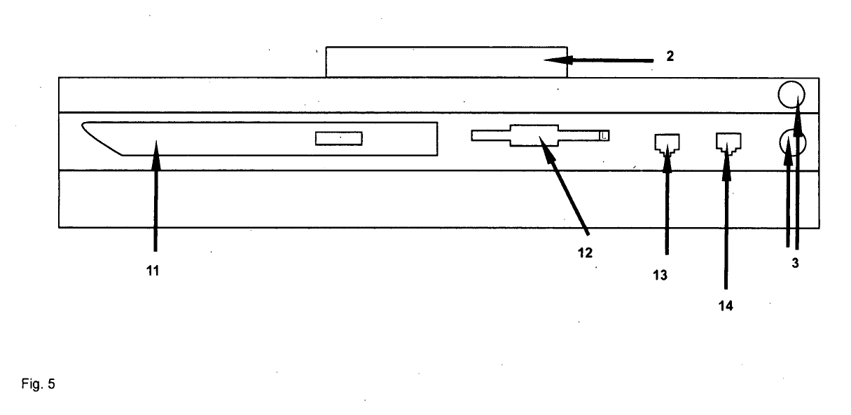

FIG. 6 is an overview of the ALI Laptop with the screen in the open position showing the features associated with the laptop keyboard area and screen.

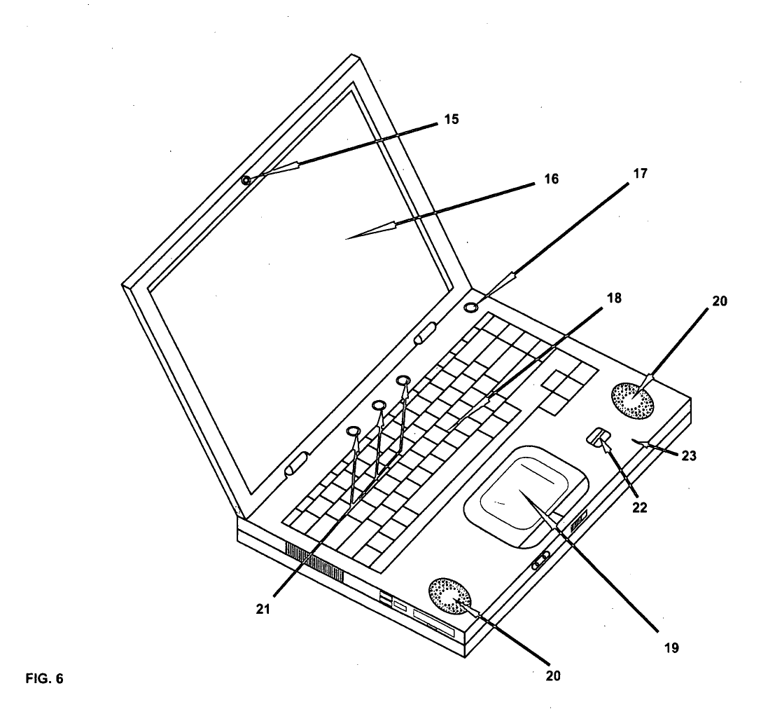

FIG. 7 is a rear view of the ALI Laptop with the laptop screen open.

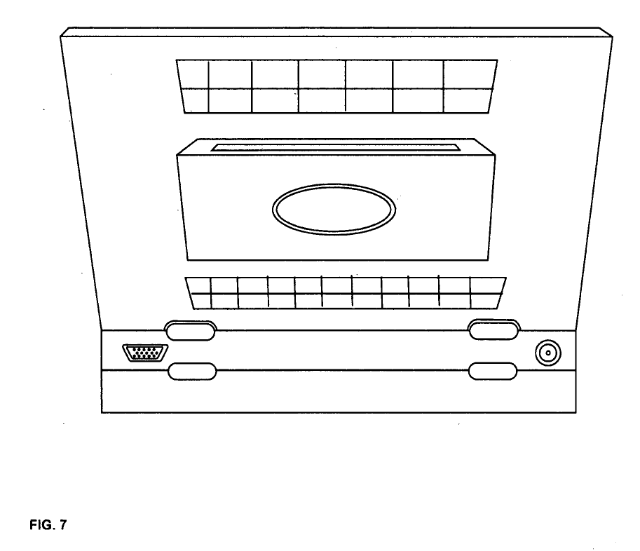

FIG. 8 is a demonstration of the opening of the ALI Laptop's Scanner compartment with computer screen open complete with side view. Screen and Scanner Compartment open shows the features of the laptop screen and keyboard area and scanner area.

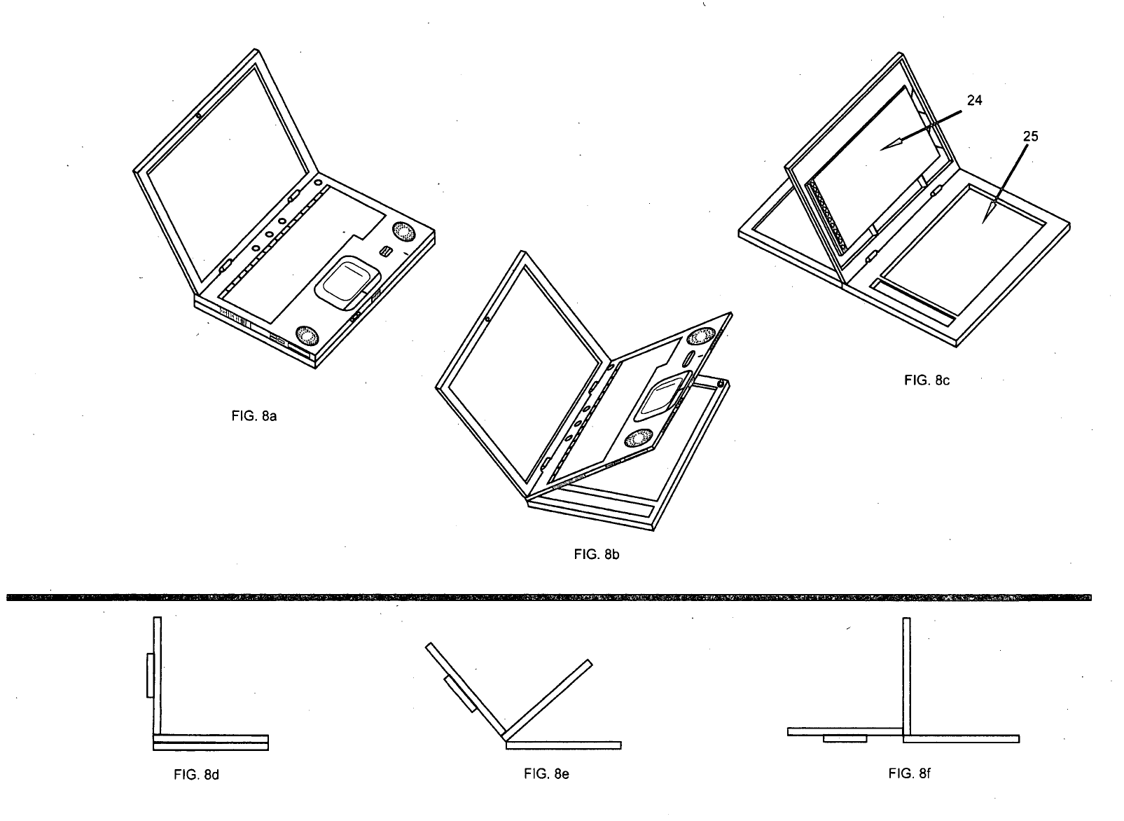

FIG. 9 is a demonstration of the opening of the ALI Laptop's Scanner compartment complete with side view.

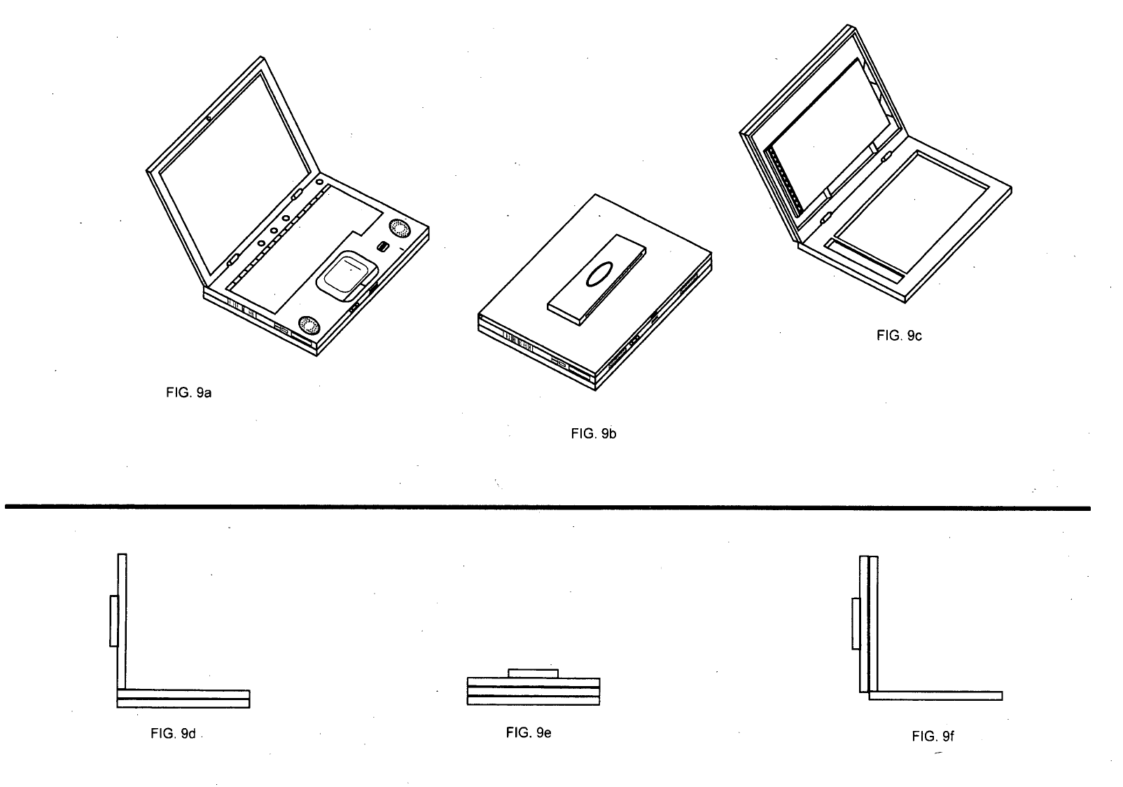

FIG. 10 is a step by step visual of how the ALI Laptop's scanner works

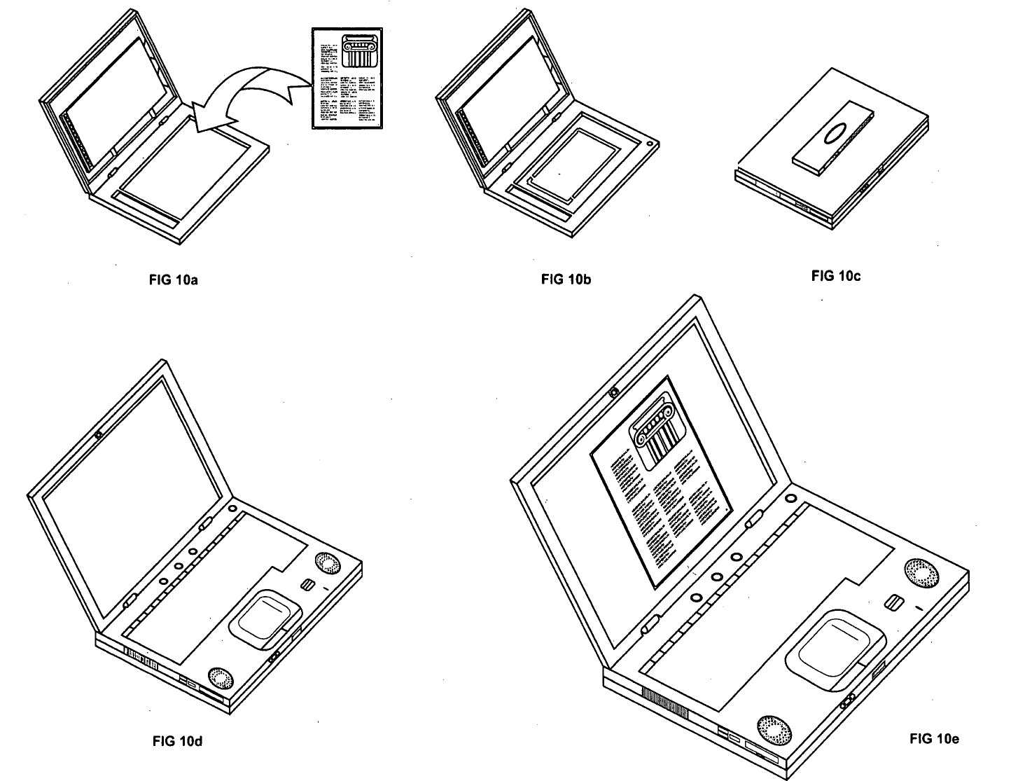

FIG. 11 is a step by step visual of how the ALI Laptop's printer works

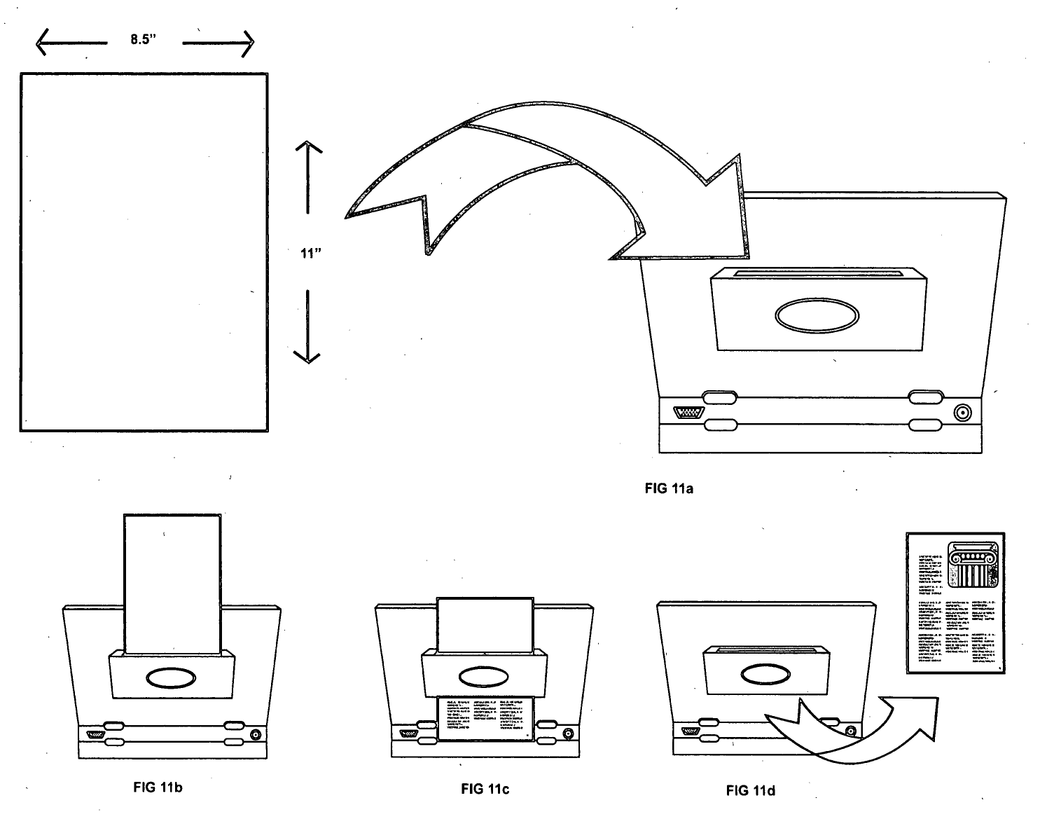

### NUMBERING IDENTIFICATION LIST

1. COMPANY LOGO
2. SMALL FEEDING PRINTER
3. HINGES
4. COOLING VENT
5. USB PORTS
6. CARD READER
7. HEADPHONE/MICROPHONE JACKS
8. LAPTOP SCREEN AND SCANNER LATCHES
9. EXTERNAL MONITOR OUTPUT
10. POWER CORD JACK
11. DVD/CD BURNER
12. FLOPPY DISC DRIVE
13. ETHERNET PORT
14. PHONE LINE PORT
15. DIGITAL CAMERA
16. TOUCH SCREEN
17. POWER BUTTON
18. ULTRA THIN KEYBOARD SECTION
19. NAVIATIONAL MOUSE WITH LEFT AND RIGHT CLICKER
20. LAPTOP SPEAKERS
21. TRIPLE QUICK KEYS
22. BIO TECHNOLOGY FINGERPRINT READER
23. MICROPHONE
24. SCANNER DOCUMENT COVER
25. SCANNER
26. MINIATURE SOLAR PANELS

### DESCRIPTION OF THE PREFERRED EMBODIMENTS

The beginning of the description of the preferred embodiments begins with the basic structure of a laptop. The ALI Laptop incorporates the basic features of most laptops which is the flip open screen which reveals the keyboard area. Around the sides are the location of basic ports such as the power port, DVD/CD drive, floppy disc drive, Ethernet and phone jacks, card readers, USB ports, headphone/microphone jacks and any other commonly found connection. The final location of these ports can be arranged according to the likes of the company.

The ALI Laptop can be made from very light weight and durable materials such as Carbon Fiber plastics for scratch resistance and extreme durability and alloy metals for light weight. Also both types of materials add to heat dissipation for better internal functioning of hardware. The ALI Laptops can be manufactured, constructed and distributed the same as conventional laptops but improved to include the new printer, scanner, fax compartments and miniature solar panels.

### The ALI Integration

What makes the ALI Laptop different than traditional laptops is first noticed in appearance with its mounted printer on back of screen creates what would seem to be a bulge but is solved with the company logo on top and merger with printer casing with screen casing. Also because of the scanner compartment, a slight thickness to laptop is created, however this is countered by the thin keyboard section.

The bottom of the ALI contains basic features commonly found in a laptop including lithium-ion battery pack and compartment for adding higher processing memory chips. The battery pack itself is wired up to the printer top where small decorative solar cells are that can help boost power. Although the solar cells can not permanently maintain full operations of the computer with its power it can add small amounts of energy to the battery during usage that can help slow the drainage of energy from the battery. Also when the computer is powered down the solar cells can feed power to the battery to slowly recharge the battery when the laptop is not plugged into an outlet.

What is claimed is:

1. An integration of external attachable accessories into the laptop itself. Such external accessories to be integrated are:
1. A printer that is built into the rear of the computer screen
2. A scanner that is built into the bottom of the computer located beneath the keyboard area in its own compartment.
3. A fax machine that is integrated in with the scanner or printer.
4. Miniature solar panels to prolong battery life.
